(19) United States
(12) Patent Application Publication
(10) Pub. No.: US 2026/0343514 A1
(43) Pub. Date: Oct. 29, 2026

(54) METHOD AND DEVICE FOR TRANSMITTING AND RECEIVING SPS AND CG FOR NETWORK ENERGY SAVING IN WIRELESS COMMUNICATION SYSTEM

(71) Applicant: Samsung Electronics Co., Ltd., Suwon-si, Gyeonggi-do (KR)

(72) Inventors: Sangkyu BAEK, Suwon-si (KR); Anil AGIWAL, Suwon-si (KR); Byounghoon JUNG, Suwon-si (KR)

(21) Appl. No.: 19/116,188

(22) PCT Filed: Sep. 26, 2023
(86) PCT No.: PCT/KR2023/014751

§ 371 Date: Mar. 27, 2025

(30) Foreign Application Priority Data
Sep. 27, 2022 (KR) 10-2022-0122550

(51) Int. Cl. H04W 72/0457; H04W 52/02; H04W 72/232

(52) U.S. Cl. CPC H04W 72/0457; H04W 72/232; H04W 52/0235

(57) ABSTRACT

The present disclosure relates to a 5G or 6G communication system for supporting higher data transmission rates. The present disclosure provides an operation method of a terminal, comprising the steps of: receiving, from a base station, information about a first bandwidth part (BWP) and a second BWP, and configuration information about periodic resources configured for each of the first BWP and the second BWP; receiving, from the base station, first downlink control information for activating a first periodic resource set in the first BWP, which is an active BWP; performing data transmission and reception on the basis of the activated first periodic resource; receiving, from the base station, active BWP change information activating the second BWP; and suspending use of the activated first periodic resource set in the first BWP, wherein the suspended use of the first periodic resource is resumed without receiving the first downlink control information when the first BWP is activated.

### TECHNICAL FIELD

The disclosure relates to operations of a terminal and a base station in a wireless communication system and, particularly, to a method and a device for transmitting and receiving SPS and CG for network power reduction.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to reduce power consumption of networks.

### DISCLOSURE OF INVENTION

### Technical Problem

Embodiments set forth herein are to provide a device and a method capable of effectively providing services in a wireless communication system.

### Solution to Problem

According to an embodiment of the disclosure, a method performed by a user equipment (UE) in a wireless communication system may include: receiving, from a base station, information on a first bandwidth part (BWP) and a second BWP, and configuration information for a periodic resource configured for each of the first BWP and the second BWP; receiving, from the base station, first downlink control information for activating a first periodic resource configured for the first BWP that is an active BWP; performing data transmission and reception, based on the activated first periodic resource; receiving, from the base station, active BWP change information for activating the second BWP; and suspending use of the activated first periodic resource configured for the first BWP, wherein the suspended use of the first periodic resource is resumed without reception of the first downlink control information when the first BWP is activated.

In addition, according to an embodiment of the disclosure, a method performed by a base station in a wireless communication system may include: transmitting, to a user equipment (UE), information on a first bandwidth part (BWP) and a second BWP, and configuration information for a periodic resource configured for each of the first BWP and the second BWP; transmitting, to the UE, first downlink control information for activating a first periodic resource configured for the first BWP that is an active BWP; performing data transmission and reception, based on the activated first periodic resource; transmitting, to the UE, active BWP change information for activating the second BWP; and suspending use of the activated first periodic resource configured for the first BWP, wherein the suspended use of the first periodic resource is resumed without transmission of the first downlink control information when the first BWP is activated.

In addition, according to an embodiment of the disclosure, a user equipment (UE) in a wireless communication system may include a transceiver, and a controller connected to the transceiver, wherein the controller is configured to perform: receiving, from a base station, information on a first bandwidth part (BWP) and a second BWP, and configuration information for a periodic resource configured for each of the first BWP and the second BWP; receiving, from the base station, first downlink control information for activating a first periodic resource configured for the first BWP that is an active BWP; performing data transmission and reception, based on the activated first periodic resource; receiving, from the base station, active BWP change information for activating the second BWP; and suspending use of the activated first periodic resource configured for the first BWP, wherein the suspended use of the first periodic resource is resumed without reception of the first downlink control information when the first BWP is activated.

In addition, according to an embodiment of the disclosure, a base station in a wireless communication system may include a transceiver, and a controller connected to the transceiver, wherein the controller is configured to perform: transmitting, to a user equipment (UE), information on a first bandwidth part (BWP) and a second BWP, and configuration information for a periodic resource configured for each of the first BWP and the second BWP; transmitting, to the UE, first downlink control information for activating a first periodic resource configured for the first BWP that is an active BWP; performing data transmission and reception, based on the activated first periodic resource; transmitting, to the UE, active BWP change information for activating the second BWP; and suspending use of the activated first periodic resource configured for the first BWP, wherein the suspended use of the first periodic resource is resumed without transmission of the first downlink control information when the first BWP is activated.

### Advantageous Effects of Invention

Embodiments of the disclosure provide a device and a method capable of effectively providing services in a wireless communication system.

### BRIEF DESCRIPTION OF DRAWINGS

FIG. 1 is a diagram illustrating a semi-persistent scheduling (SPS) transmission and reception scheme in accordance with bandwidth part (BWP) switching according to an embodiment of the disclosure.

FIG. 2 is a diagram illustrating a configured grant (CG) transmission and reception scheme in accordance with BWP switching according to an embodiment of the disclosure.

FIG. 3 is a diagram illustrating an SPS transmission and reception scheme in accordance with BWP switching according to an embodiment of the disclosure.

FIG. 4 is a diagram illustrating a CG transmission and reception scheme in accordance with BWP switching according to an embodiment of the disclosure.

FIG. 5 is a diagram illustrating a message format for configuring an SPS or CG type according to an embodiment of the disclosure.

FIG. 6 is a diagram illustrating a transmission and reception scheme based on an SPS group according to an embodiment of the disclosure.

FIG. 7 is a diagram illustrating a transmission and reception scheme based on a CG group according to an embodiment of the disclosure.

FIG. 8 is a diagram illustrating a transmission and reception scheme based on an SPS group according to an embodiment of the disclosure.

FIG. 9 is a diagram illustrating a transmission and reception scheme based on a CG group according to an embodiment of the disclosure.

FIG. 10 is a diagram illustrating a CG transmission and reception scheme in accordance with BWP switching according to an embodiment of the disclosure.

FIG. 11 is a diagram illustrating UE capability transmission and RRC configuration schemes according to an embodiment of the disclosure.

FIG. 12 illustrates a structure of a base station according to an embodiment of the disclosure.

FIG. 13 illustrates a structure of a UE according to an embodiment of the disclosure.

### MODE FOR CARRYING OUT THE INVENTION

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. Hereinafter, embodiments of the disclosure will be described with reference to the accompanying drawings.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3GPP long term evolution (3GPP LTE) standards will be used for the sake of descriptive convenience. However, the disclosure is not limited by these terms and names, and may be applied in the same way to systems that conform other standards. In the disclosure, the term “g NB” may be interchangeably used with the term “e NB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHZ or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

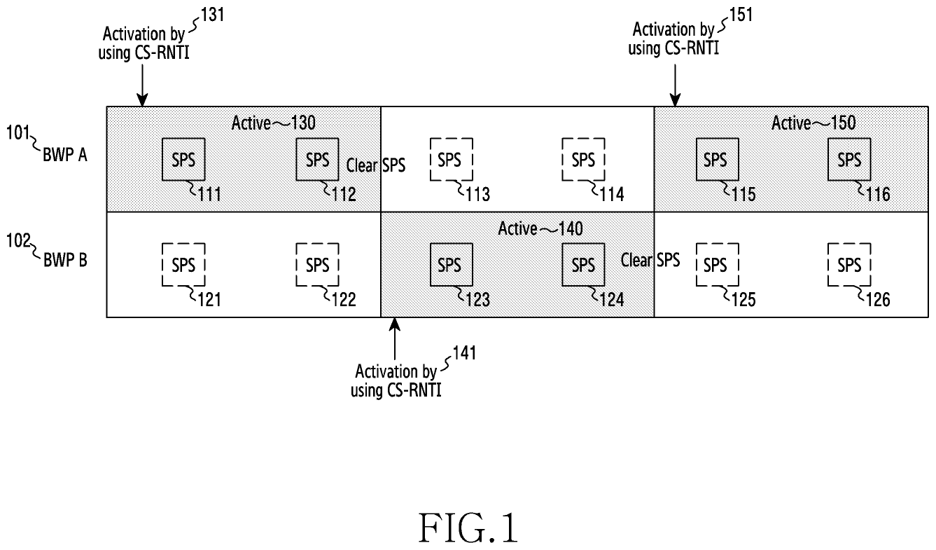

FIG. 1 is a diagram illustrating an SPS operation scheme in accordance with BWP switching according to an embodiment of the disclosure.

In order to transmit periodic data, such as voice, or ultra-reliable and low latency communication (URLLC) data requiring low latency, a base station in a wireless communication system may configure a semi-persistent scheduling (SPS) resource which is a downlink (transmission from the base station to a UE) radio resource periodically configured for a UE.

According to an embodiment of the disclosure, an SPS resource may be configured by a radio resource control (RRC) reconfiguration message that the base station transmits to the UE. The SPS resource may be configured for a predetermined bandwidth part (BWP). The base station may configure at least one BWP, and the at least one BWP may be activated or deactivated by the base station. An activated BWP is referred to as an active BWP.

In the embodiment of FIG. 1, two BWPs of BWP A 101 and BWP B 102 are configured, periodic SPS transmission resources 111, 112, 113, 114, 115, and 116 are configured for BWP A 101, and other periodic SPS transmission resources 121, 122, 123, 124, 125, and 126 are configured for BWP B 102.

Referring to FIG. 1, after the SPS transmission resources are configured, the base station may indicate activation of the SPS resources to the UE in a downlink control information (DCI) message of a physical downlink control channel (PDCCH) by using configured scheduling-radio network temporary identity (CS-RNTI). When activation of the SPS resources is indicated, the SPS transmission resources for which activation has been indicated may be used, and the UE may perform data reception using the SPS resources from the base station. The embodiment of FIG. 1 illustrates that the base station indicates, to the UE by using CS-RNTI 131, activation of the SPS transmission resources configured for BWP A 101 that is a current active BWP. Then, the SPS transmission resources 111 and 112 configured for BWP A 101 are activated, and the UE may perform data reception.

Data transmission using the SPS resources may be performed only when the BWP for which SPS has been configured is activated. At a point in time when BWP B 102 is not an active BWP, the SPS transmission resources 121, 122, 125, and 126 configured for BWP B 102 may not be used. In addition, exact locations of the SPS resources may not be configured.

If the active BWP is changed to BWP B 102 later, the SPS resources configured for BWP A 101 that is the existing active BWP are deleted (cleared), and the SPS resources 113 and 114 of BWP A are not used. If SPS configured for BWP B 102 that is the active BWP is not activated immediately, and the SPS transmission resources configured for BWP B are activated using CS-RNTI 141, the SPS resources 123 and 124 may be activated. Similarly, if the active BWP is changed back to BWP A 101 later, the SPS resources configured for BWP B 102 that is the existing active BWP are deleted (cleared), and the SPS resources 125 and 126 of BWP B 102 are not used. If SPS configured for BWP A 101 that is the active BWP is not activated immediately, and the SPS transmission resources configured for BWP B are activated using CS-RNTI 151, the SPS resources 115 and 116 may be activated.

If a BWP switching operation in which the active BWP of the UE is changed occurs frequently, the base station may need to frequently transmit a message (e.g., the CS-RNTI 131, 141, and 151) indicating activation of the SPS resources to the UE. In particular, if the operation in which the active BWP is changed is performed periodically at a determined time, the repeated messages indicating activation of the SPS resources may result in the waste of PDCCH resources. The operation in which the active BWP is changed may be performed frequently for network energy saving (NES) purposes.

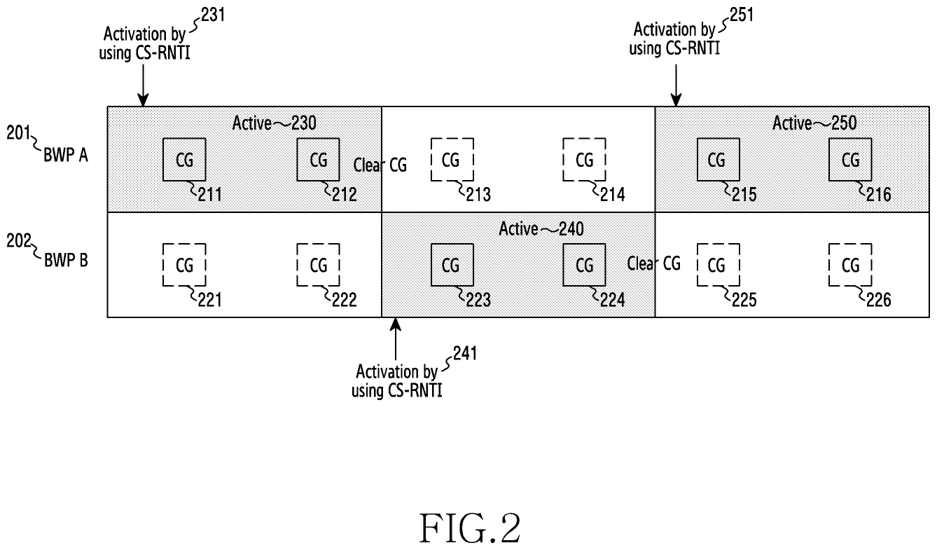

FIG. 2 is a diagram illustrating a CG operation scheme in accordance with BWP switching according to an embodiment of the disclosure.

In order to transmit periodic data, such as voice, or ultra-reliable and low latency communication (URLLC) data requiring low latency, a base station in the wireless communication system may configure a configured grant (CG) resource which is an uplink (transmission from a UE to the base station) radio resource periodically configured for a UE.

According to an embodiment of the disclosure, a CG resource may be configured by a radio resource control (RRC) reconfiguration message that the base station transmits to the UE. The CG resource may be configured on a bandwidth part (BWP). The base station may configure at least one BWP, and the at least one BWP may be activated or deactivated by the base station. An activated BWP is referred to as an active BWP.

In the embodiment of FIG. 2, two BWPs of BWP A 201 and BWP B 202 are configured, periodic CG transmission resources 211, 212, 213, 214, 215, and 216 are configured for BWP A 201, and other periodic CG transmission resources 221, 222, 223, 224, 225, and 226 are configured for BWP B 202.

According to an embodiment of the disclosure, the CG resources may be divided into a first type of CG and a second type of CG. The first type of CG may refer to CG resources used immediately after being configured by an RRC reconfiguration message, and the second type of CG may refer to CG resources indicating CG resource activation to the UE by the base station in a downlink control information (DCI) message of a physical downlink control channel (PDCCH) by using configured scheduling-radio network temporary identity (CS-RNTI) after the CG transmission resources are configured by an RRC reconfiguration message.

The embodiment of FIG. 2 illustrates an operation of the second type of CG resources. When activation of the CG resources is indicated, the CG transmission resources for which activation has been indicated may be actually used, and the UE may perform data transmission using the CG resources to the base station. The embodiment of FIG. 2 illustrates that the base station indicates, to the UE by using CS-RNTI 231, activation of the CG transmission resources configured for BWP A 201 that is a current active BWP. Then, the CG transmission resources 211 and 212 configured for BWP A 201 are activated, and the UE performs data transmission.

Data transmission using the CG resources may be performed only when the BWP for which CG has been configured is activated. At a point in time when BWP B 202 is not an active BWP, the CG transmission resources 221, 222, 225, and 226 configured for BWP B 202 are not actually used. In addition, exact locations of the CG resources may not be configured.

If the active BWP is changed to BWP B 202 later, the CG resources configured for BWP A 201 that is the active BWP are deleted (cleared), and the CG resources 213 and 214 of BWP A 201 are not used. If CG configured for BWP B 202 that is the active BWP is not activated immediately, and the CG transmission resources configured for BWP B 202 are activated using CS-RNTI 241, the CG resources 223 and 224 may be activated. Similarly, if the active BWP is changed back to BWP A 201 later, the CG resources configured for BWP B 202 that is the existing active BWP are deleted (cleared), and the CG resources 225 and 226 of BWP B 202 are not used. If CG configured for BWP A 201 that is the active BWP is not activated immediately, and the CG transmission resources configured for BWP B 202 are activated using CS-RNTI 251, the CG resources 215 and 216 may be activated.

If a BWP switching operation in which the active BWP of the UE is changed occurs frequently, the base station may need to frequently transmit a message (e.g., the CS-RNTI 231, 241, and 251) indicating activation of the CG resources to the UE. In particular, if the operation in which the active BWP is changed is performed periodically at a determined time, the repeated messages indicating activation of the CG resources may result in the waste of PDCCH resources. The operation in which the active BWP is changed may be performed frequently for network energy saving (NES) purposes.

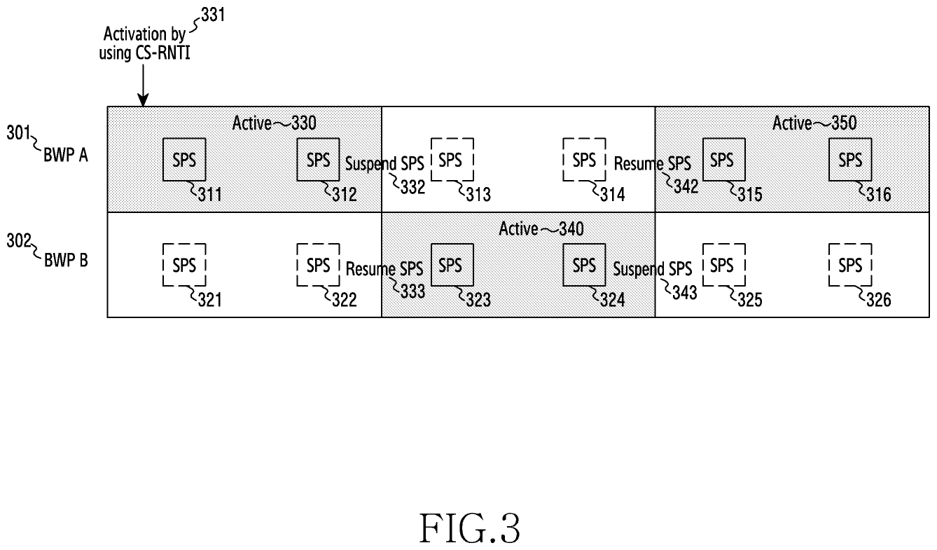

FIG. 3 is a diagram illustrating an SPS operation scheme in accordance with BWP switching according to an embodiment of the disclosure.

When a base station configures SPS resources which are downlink (transmission to a UE by the base station) radio resources periodically configured for a UE, the SPS resources may be configured by an RRC reconfiguration message that the base station transmits to the UE. The SPS resources may be configured on a BWP. The base station may configure at least one BWP, and the at least one BWP may be activated or deactivated by the base station. An activated BWP is referred to as an active BWP.

In the embodiment of FIG. 3, two BWPs of BWP A 301 and BWP B 302 are configured, periodic SPS transmission resources 311, 312, 313, 314, 315, and 316 are configured for BWP A 301, and other periodic SPS transmission resources 321, 322, 323, 324, 325, and 326 are configured for BWP B 302. After the SPS transmission resources are configured, the base station may indicate activation of the SPS resources to the UE in a downlink control information (DCI) message of a physical downlink control channel (PDCCH) by using configured scheduling-radio network temporary identity (CS-RNTI). When activation of the SPS resources is indicated, the SPS transmission resources for which activation has been indicated may be actually used, and the UE may perform data reception using the SPS resources from the base station. The embodiment of FIG. 3 illustrates that the base station indicates, to the UE by using CS-RNTI 331, activation of the SPS transmission resources configured for BWP A 301 that is a current active BWP. Then, the SPS transmission resources 311 and 312 configured for BWP A are activated, and the UE performs data reception.

Data transmission using the SPS resources may be performed only when the BWP for which SPS has been configured is activated. At a point in time when BWP B 302 is not an active BWP, the SPS transmission resources 321, 322, 325, and 326 configured for BWP B 302 may not be used. In addition, exact locations of the SPS resources may not be configured.

If the active BWP is changed to BWP B later, the SPS resources configured for BWP A 301 that is the existing active BWP are suspended 332, and the SPS resources 313 and 314 of BWP A 301 are not used. However, locations of the SPS resources 313, 314, 315, and 316 configured for BWP A may be maintained by the UE and the base station, and may be prepared for use when BWP A 301 later becomes the active BWP again. In other words, the UE and the base station may maintain, store, or deactivate configuration information on the SPS resources configured for BWP A 301.

If SPS configured for BWP B 302 that is the active BWP has been previously activated, data transmission using the SPS resources 323 and 324 may be resumed 333 immediately without an activation stage using CS-RNTI. Similarly, if the active BWP is changed back to BWP A 301 later, the SPS resources configured for BWP B 302 that is the existing active BWP are suspended 343, and the SPS resources 325 and 326 of BWP B 302 are not used. However, locations of the SPS resources 325 and 326 configured for BWP B may be maintained by the UE and the base station, and may be prepared for use when BWP B 302 later becomes the active BWP again.

Since SPS configured for BWP A 301 that is the active BWP has been previously activated, the SPS resources 315 and 316 may be resumed 342 immediately without an activation stage using CS-RNTI.

According to the scheme proposed in the embodiment of FIG. 3, even if a BWP switching operation in which the active BWP of the UE is changed occurs frequently, the base station does not need to frequently transmit a message (e.g., the CS-RNTI 331) indicating activation of the SPS resources to the UE. In particular, if the operation in which the active BWP is changed is performed periodically at a determined time, the repeated messages indicating activation of the SPS resources may have an advantage of reducing problems of wasting PDCCH resources.

According to an embodiment of the disclosure, separate configuration may be performed for a type of SPS for performing an operation in which, for previously activated SPS resources, if a BWP to which the SPS resources belong is not an active BWP, reception using the SPS resources is suspended, and when the BWP becomes an active BWP later, the SPS resources are resumed without a separate activation procedure.

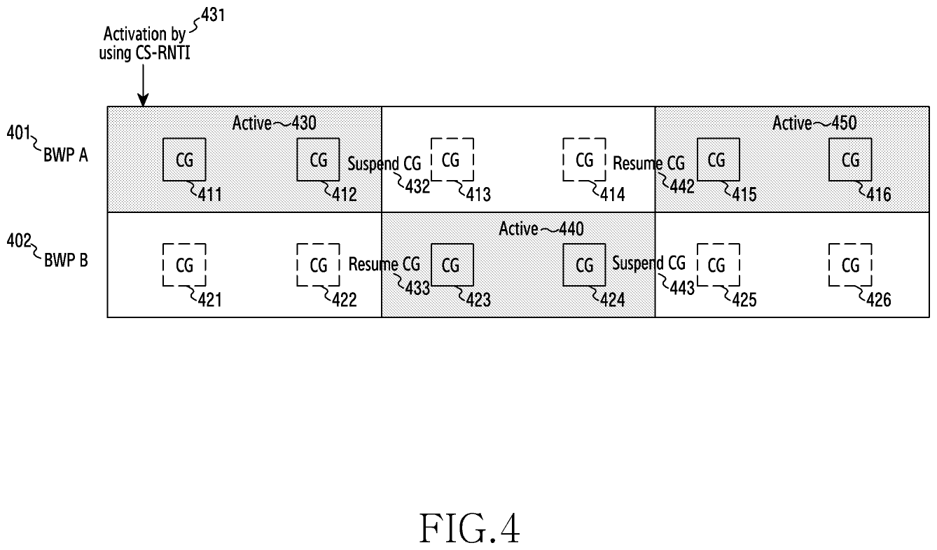

FIG. 4 is a diagram illustrating a CG operation scheme in accordance with BWP switching according to an embodiment of the disclosure.

When a base station configures CG resources which are uplink (transmission to the base station by a UE) radio resources periodically configured for a UE, the CG resources may be configured by an RRC reconfiguration message that the base station transmits to the UE. The CG resources may be configured on a BWP. The base station may configure at least one BWP, and the at least one BWP may be activated or deactivated by the base station. An activated BWP is referred to as an active BWP.

In the embodiment of FIG. 4, two BWPs of BWP A 401 and BWP B 402 are configured, periodic CG transmission resources 411, 412, 413, 414, 415, and 416 are configured for BWP A 401, and other periodic CG transmission resources 421, 422, 423, 424, 425, and 426 are configured for BWP B 402.

According to an embodiment of the disclosure, the CG resources may be divided into a first type of CG and a second type of CG. The first type of CG may refer to CG resources used immediately after being configured by an RRC reconfiguration message, and the second type of CG may refer to CG resources indicating CG resource activation to the UE by the base station in a downlink control information (DCI) message of a physical downlink control channel (PDCCH) by using configured scheduling—radio network temporary identity (CS-RNTI) after the CG transmission resources are configured by an RRC reconfiguration message.

The embodiment of FIG. 4 illustrates an operation of the second type of CG resources. When activation of the CG resources is indicated, the CG transmission resources for which activation has been indicated may be actually used, and the UE may perform data transmission using the CG resources to the base station. The embodiment of FIG. 4 illustrates that the base station indicates, to the UE by using CS-RNTI 431, activation of the CG transmission resources configured for BWP A 401 that is a current active BWP. Then, the CG transmission resources 411 and 412 configured for BWP A are activated, and the UE performs data transmission.

Data transmission using the CG resources may be performed only when the BWP for which CG has been configured is activated. At a point in time when BWP B 402 is not an active BWP, the CG transmission resources 421, 422, 425, and 426 configured for BWP B 402 are not actually used. In addition, exact locations of the CG resources may not be configured.

If the active BWP is changed to BWP B later, the CG resources configured for BWP A 401 that is the existing active BWP are suspended 432, and the CG resources 413 and 414 of BWP A are not used. However, locations of the CG resources 413, 414, 415, and 416 configured for BWP A may be maintained by the UE and the base station, and may be prepared for use when BWP A 401 later becomes the active BWP again. In other words, the UE and the base station may maintain, store, or deactivate configuration information on the SPS resources configured for BWP A 401.

If CG configured for BWP B 402 that is the active BWP has been previously activated, data transmission using the CG resources 423 and 424 may be resumed 433 immediately without an activation stage using CS-RNTI. Similarly, if the active BWP is changed back to BWP A 401 later, the CG resources configured for BWP B 402 that is the existing active BWP are suspended 443, and the CG resources 425 and 426 of BWP B 402 are not used. However, locations of the CG resources 425 and 426 configured for BWP B 402 may be maintained by the UE and the base station, and may be prepared for use when BWP B 402 later becomes the active BWP again.

Since CG configured for BWP A 401 that is the active BWP has been previously activated, the CG resources 415 and 416 may be resumed 442 immediately without an activation stage using CS-RNTI. According to the scheme proposed in the embodiment of FIG. 4, even if a BWP switching operation in which the active BWP of the UE is changed occurs frequently, the base station does not need to frequently transmit a message (e.g., the CS-RNTI 431) indicating activation of the CG resources to the UE. In particular, if the operation in which the active BWP is changed is performed periodically at a determined time, repeated messages indicating activation of the CG resources may have an advantage of reducing problems of wasting PDCCH resources.

According to an embodiment of the disclosure, separate configuration may be performed for a type of CG for performing an operation in which, for previously activated CG resources, if a BWP to which the CG resources belong is not an active BWP, reception using the CG resources is suspended, and when the BWP becomes an active BWP later, the CG resources are resumed without a separate activation procedure.

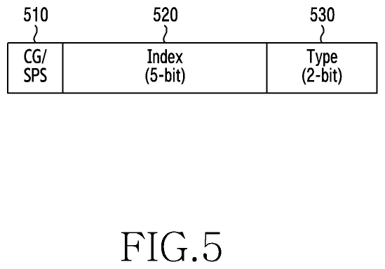

FIG. 5 is a diagram illustrating a message format for configuring an SPS or CG type according to an embodiment of the disclosure.

According to an embodiment of the disclosure, the CG resources may be divided into a first type of CG and a second type of CG. The first type of CG may refer to CG resources used immediately after being configured by an RRC reconfiguration message, and the second type of CG may refer to CG resources indicating CG resource activation to a UE by a base station in a downlink control information (DCI) message of a physical downlink control channel (PDCCH) by using configured scheduling—radio network temporary identity (CS-RNTI) after the CG transmission resources are configured by an RRC reconfiguration message.

The second type of CG may be deleted (cleared) when a BWP is deactivated and becomes a non-active BWP. In addition, as proposed in FIG. 4, a type of CG in which, even for CG resources indicating CG resource activation in a DCI message of a PDCCH by using CS-RNTI, the CG resources are suspended without being cleared even when a BWP is deactivated, and then resumed after the BWP becomes an active BWP, may be newly defined.

According to an embodiment of the disclosure, the type of CG in which, even for CG resources indicating CG resource activation in a DCI message of a PDCCH by using CS-RNTI, the CG resources are suspended without being cleared even when a BWP is deactivated, and then resumed after the BWP becomes an active BWP, may be referred to as a third type.

SPS may be deleted (cleared) when a BWP is deactivated and becomes a non-active BWP. According to an embodiment, this SPS may be referred to as a first type of SPS. In addition, as proposed in FIG. 3, a type of SPS in which, even for SPS resources indicating SPS resource activation in a DCI message of a PDCCH by using CS-RNTI, the SPS resources are suspended without being cleared even when a BWP is deactivated, and then resumed after the BWP becomes an active BWP, may be newly defined.

According to an embodiment of the disclosure, the type of SPS in which, even for SPS resources indicating SPS resource activation in a DCI message of a PDCCH by using CS-RNTI, the SPS resources are suspended without being cleared even when a BWP is deactivated, and then resumed after the BWP becomes an active BWP, may be referred to as a second type of SPS.

Various types of CG or SPS may be defined, and each thereof may have different characteristics. However, the types of CG or SPS are uplink or downlink resources configured periodically, and may thus have in common that resource information, such as a period, is configured. According to an embodiment of the disclosure, an operation of changing a type of each CG or SPS resource may be required. Changing a type of CG or SPS may enable low-latency transmission, etc. by minimizing deactivated radio resources and reducing used radio resources due to reduction of the number of message transmissions according to a radio resource operation situation of a base station.

To this end, the embodiment of FIG. 5 illustrates a format of a message for changing a type of CG or SPS. The embodiment of FIG. 5 illustrates a CG/SPS type change message in a format of a medium access control-control element (MAC CE) that a base station transmits to a UE. Of course, it is also possible to change a CG/SPS type via a message format other than the MAC CE format. For example, it is also possible to change a CG/SPS type via a message, such as RRC signaling, rather than the MAC CE.

According to an embodiment of the disclosure, the CG/SPS type change message may have all or some of a 1-bit CG/SPS field 510, a 5-bit index field 520, and a 2-bit type field 530. Of course, the CG/SPS type change message is not limited to the example, and the number of bits in each field may be changed.

According to an embodiment of the disclosure, the CG/SPS field 510 refers to a field indicating whether a resource of a type that is to be changed is uplink CG or downlink SPS, and values of 0 and 1 may refer to values indicating whether the resource of the type is CG and SPS, respectively. (Conversely, 0 may refer to SPS, and 1 may refer to CG.) The index field 520 may indicate an index value of CG or SPS, the type of which is to be changed.

According to an embodiment of the disclosure, a value indicated in the index field 520 may be an index value (may be an identity in another embodiment) of CG or SPS, which is unique within a MAC device. In addition, according to an embodiment of the disclosure, a value indicated in the index field 520 may be an index value of the only CG or SPS within a BWP in which the MAC CE is transmitted.

According to an embodiment of the disclosure, the type field 530 may be a value for configuration of a type of the corresponding CG or SPS. For example, for CG, in the type field 530, a value corresponding to one of the aforementioned first type, second type, and third type may be configured. A CG/SPS type change MAC CE may be transmitted by the base station to the UE. To this end, configuration information of CG or SPS may be configured in advance in an RRC reconfiguration message, and the type of CG or SPS may be dynamically changed by the MAC CE.

According to an embodiment of the disclosure, when the UE receives the CG/SPS type change MAC CE, the type of the corresponding CG or SPS may be changed. In addition, when the base station configures the type of CG or SPS for the UE, the type of CG or SPS may be configured as an initial value. For example, the base station may configure a default CG or SPS type for the UE. If the type of CG or SPS is changeable by the MAC CE, all necessary information may be configured for CG or SPS configuration information regardless of the type, but only some of the information may be actually used depending on an applied type. For example, for the second type of CG, a modulation and coding scheme (MCS) value that is used may be configured by an RRC message, but for the second type of CG, the MCS value may be ignored and not used, and an MCS value indicated by DCI may be applied. However, when the type is changed to the first type of CG, the MCS value may be used.

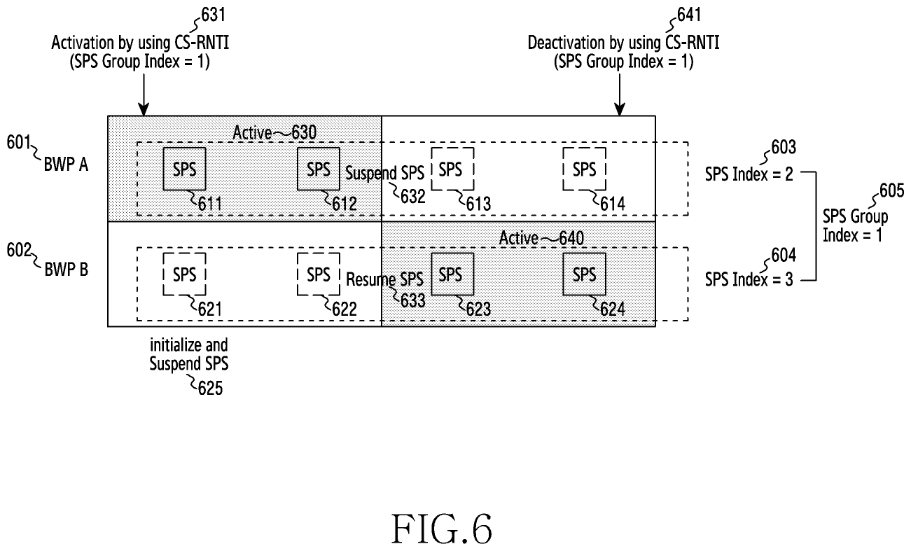

FIG. 6 is a diagram illustrating an operation scheme of an SPS group according to an embodiment of the disclosure.

According to an embodiment of the disclosure, when a base station configures SPS resources which are downlink (transmission to a UE by the base station) radio resources periodically configured for a UE, the SPS resources may be configured by an RRC reconfiguration message that the base station transmits to the UE. The SPS resources may be configured on a BWP. The base station may configure at least one BWP, and the at least one BWP may be activated or deactivated by the base station. An activated BWP is referred to as an active BWP.

In the embodiment of FIG. 6, two BWPs of BWP A 601 and BWP B 602 are configured, periodic SPS transmission resources 611, 612, 613, and 614 are configured for BWP A 601, and other periodic SPS transmission resources 621, 622, 623, and 624 are configured for BWP B 602. It is assumed that SPS configured for BWP A 601 has an SPS index value 603 of 2, and SPS configured for BWP B 602 has an SPS index value 604 of 3. SPS of index 2 603 and SPS of index 3 604 are configured to be in the same SPS group, and indicate to have an SPS group index 605 of 1 indicating which group it is.

According to an embodiment of the disclosure, SPS resources of the same SPS group may be simultaneously activated or deactivated. In addition, according to an embodiment of the disclosure, the configuration of the SPS group may be configured by the RRC reconfiguration message.

After the SPS transmission resources are configured, the base station may indicate SPS group activation to the UE in a downlink control information (DCI) message of a physical downlink control channel (PDCCH) by using configured scheduling-radio network temporary identity (CS-RNTI). SPS group activation may be performed by indicating SPS resources of which SPS group are indicated to be activated, based on the SPS group index included in the DCI. When SPS group activation is indicated, all SPS transmission resources within a corresponding SPS group may be activated. In addition, the DCI message may include configuration information of each SPS transmission resource, so that the exact location of the resource and other configuration information may be configured.

The embodiment of FIG. 6 illustrates that the base station indicates, to the UE by using CS-RNTI 631, activation of the SPS group having the SPS index 605 of 1. Then, the SPS transmission resources 611 and 612 configured for BWP A 601 are activated, and the UE performs data reception. Data transmission using the SPS resources may be performed only when the BWP for which SPS has been configured is activated. Since BWP B 602 is not an active BWP at this point in time, the SPS resources having the SPS index 604 of 3 configured for BWP B 602 are immediately suspended 625 as soon as activation by resource initialization is performed, so that the SPS transmission resources 621 and 622 cannot be used.

If the active BWP is changed to BWP B 602 later, the SPS resources configured for BWP A 601 that is the existing active BWP are suspended 632, and the SPS resources 613 and 614 of BWP A 601 are not used. However, locations of the SPS resources 613 and 614 configured for BWP A may be maintained by the UE and the base station, and may be prepared for use when BWP A later becomes the active BWP again. In other words, the UE and the base station may maintain, store, or deactivate configuration information on the SPS resources configured for BWP A 601.

For the SPS configured for BWP B 602 that is the active BWP, the SPS group has been previously activated, the SPS resources 623 and 624 may be resumed 633 immediately without an activation stage using CS-RNTI. Then, the base station may indicate, to the UE by using CS-RNTI 641, deactivation of the SPS group having the SPS group index 605 of 1 in the DCI message of the PDCCH. SPS group deactivation may indicate, by including an SPS group index in the DCI, SPS resources of which SPS group are deactivated, and when SPS group deactivation is indicated, all SPS transmission resources within a corresponding SPS group may be deactivated. In this way, the operations in which an SPS group is configured so as to be activated or deactivated may have an advantage of reducing the waste of radio resources due to separate message transmission for SPS transmission resource activation.

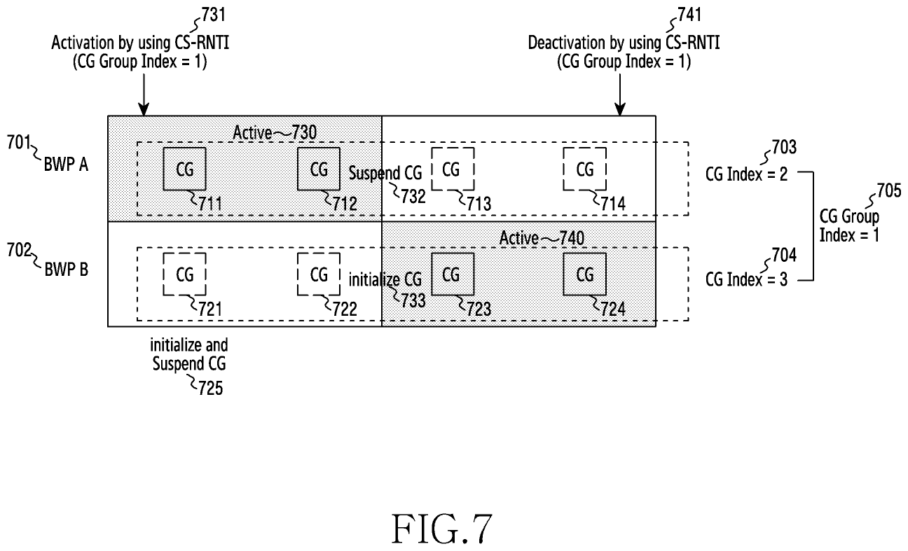

FIG. 7 is a diagram illustrating an operation scheme of a CG group according to an embodiment of the disclosure.

According to an embodiment of the disclosure, when a base station configures CG resources which are uplink (transmission to the base station by a UE) radio resources periodically configured for a UE, the CG resources may be configured by an RRC reconfiguration message that the base station transmits to the UE. The CG resources may be configured on a BWP. The base station may configure at least one BWP, and the at least one BWP may be activated or deactivated by the base station. An activated BWP is referred to as an active BWP.

In the embodiment of FIG. 7, two BWPs of BWP A 701 and BWP B 702 are configured, periodic CG transmission resources 711, 712, 713, and 714 are configured for BWP A 701, and other periodic CG transmission resources 721, 722, 723, and 724 are configured for BWP B 702. It is assumed that CG configured for BWP A 701 has a CG index value 703 of 2, and CG configured for BWP B 702 has an SPS index value 704 of 3. CG of index 2 703 and CG of index 3 704 are configured to be in the same CG group, and indicate to have a CG group index 705 of 1 indicating which group it is.

According to an embodiment of the disclosure, CG resources of the same CG group may be simultaneously activated or deactivated. In addition, according to an embodiment of the disclosure, the configuration of the CG group may be configured by the RRC reconfiguration message.

After the CG transmission resources are configured, the base station may indicate CG group activation to the UE in a downlink control information (DCI) message of a physical downlink control channel (PDCCH) by using configured scheduling-radio network temporary identity (CS-RNTI). CG group activation may be performed by indicating CG resources of which CG group are activated, based on the CG group index included in the DCI, and when CG group activation is indicated, all CG transmission resources within a corresponding CG group may be activated. In addition, the DCI message may include configuration information of each CG transmission resource so that the exact location of the resource and other configuration information may be configured.

The embodiment of FIG. 7 illustrates that the base station indicates, to the UE by using CS-RNTI 731, activation of the CG group having the CG index 705 of 1. Then, the CG transmission resources 711 and 712 configured for BWP A 701 are activated, and the UE performs data transmission. Data transmission using the CG resources may be performed only when the BWP for which CG has been configured is activated. Since BWP B 702 is not an active BWP at this point in time, the CG resources having the CG index of 3 configured for BWP B 702 are immediately suspended 725 as soon as activation by resource initialization is performed, so that the CG transmission resources 721 and 722 cannot be used.

If the active BWP is changed to BWP B 702 later, the CG resources configured for BWP A 701 that is the existing active BWP are suspended 732, and the CG resources 713 and 714 of BWP A 702 are not used. However, locations of the CG resources 713 and 714 configured for BWP A may be maintained by the UE and the base station, and may be prepared for use when BWP A later becomes the active BWP again. In other words, the UE and the base station may maintain, store, or deactivate configuration information on the SPS resources configured for BWP A 701.

For the CG configured for BWP B 702 that is the active BWP, the CG group has been previously activated, the CG resources 723 and 724 may be resumed 733 immediately without an activation stage using CS-RNTI. Then, the base station may indicate, to the UE by using CS-RNTI 741, deactivation of the CG group having the CG group index 705 of 1 in the DCI message of the PDCCH. CG group deactivation may indicate, by including a CG group index in the DCI, CG resources of which CG group are deactivated, and when CG group deactivation is indicated, all CG transmission resources within a corresponding CG group may be deactivated. In this way, the operations in which a CG group is configured so as to be activated or deactivated may have an advantage of reducing the waste of radio resources due to separate message transmission for CG transmission resource activation.

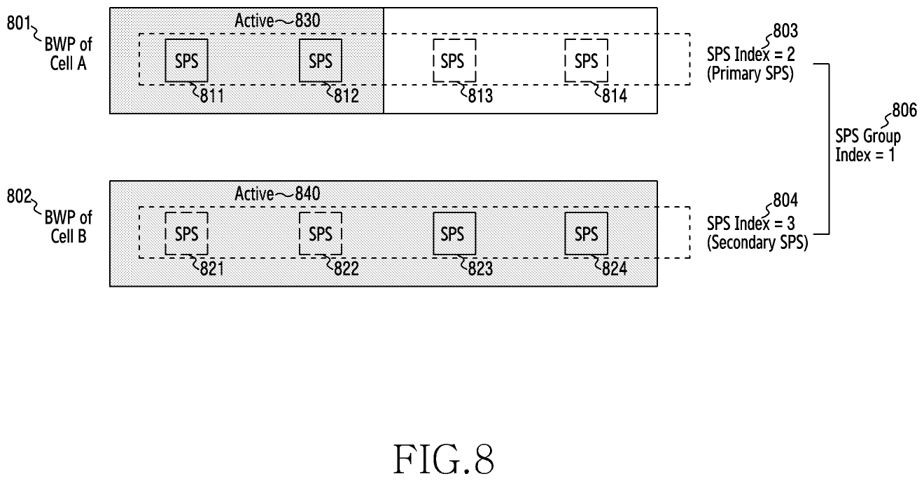

FIG. 8 is a diagram illustrating an operation scheme of an SPS group according to an embodiment of the disclosure.

According to an embodiment of the disclosure, when a base station configures SPS resources which are downlink (transmission to a UE by the base station) radio resources periodically configured for a UE, the SPS resources may be configured by an RRC reconfiguration message that the base station transmits to the UE. The SPS resources may be configured on a BWP. The base station may configure at least one BWP, and the at least one BWP may be activated or deactivated by the base station. An activated BWP is referred to as an active BWP.

The embodiment of FIG. 8 illustrates one BWP 801 among BWPs of cell A and one BWP 802 among BWPs of cell B, but one or more BWPs may be configured for each cell. The embodiment illustrates that periodic SPS transmission resources 811, 812, 813, and 814 are configured for BWP 801 of cell A, and other periodic SPS transmission resources 821, 822, 823, and 824 are configured for BWP 802 of cell B. It is assumed that SPS configured for BWP 801 of cell A has an SPS index value 803 of 2, and SPS configured for BWP 802 of cell B has an SPS index value 804 of 3. SPS of index 2 803 and SPS of index 3 804 are configured to be in the same SPS group, and indicate to have an SPS group index 805 of 1 indicating which group it is.

The embodiment of FIG. 8 illustrates a method of using only one SPS at a specific time point among a plurality of SPS configured as an SPS group. In the wireless communication network, there may be one active BWP per cell at a specific time point, and an SPS transmission resource configured for a BWP other than the active BWP cannot be used. SPS resources may be used for data transmission performed periodically and continuously, and in this case, incapability of using the SPS resources due to deactivation of a BWP may reduce transmission efficiency. Conversely, there may be no need to use two or more SPS resources within an SPS group. Therefore, an operation of using one SPS resource of SPS configured within the SPS group may be required. To this end, priorities of SPS resources within the SPS group may be configured.

The embodiment of FIG. 8 illustrates an operation in which the SPS having the SPS index 803 of 2 configured for BWP 801 of cell A is configured as primary SPS, and the SPS having the SPS index 804 of 3 configured for BWP 802 of cell B is configured as secondary SPS, wherein the SPS having the SPS index of 2 has priority.

Specifically, if primary SPS resources are configured for a current active BWP, the UE may perform data reception using the primary SPS resources. If the primary SPS resources are not resources configured for the current active BWP (in case of resources configured for a deactivated BWP), the UE may perform data reception using secondary SPS resources.

In the embodiment of FIG. 8, at a point in time when BWP 801 of cell A, for which the primary SPS has been configured, is an active BWP, data reception using the primary SPS resources 811 and 812 may be performed, and when BWP 801 of cell A is deactivated, the primary SPS resources 813 and 814 cannot be used, so that data reception using the secondary SPS resources 823 and 824 configured for BWP 802 of cell B may be performed. Information on which SPS is to be the primary SPS may be configured together when the SPS is configured in the RRC reconfiguration message.

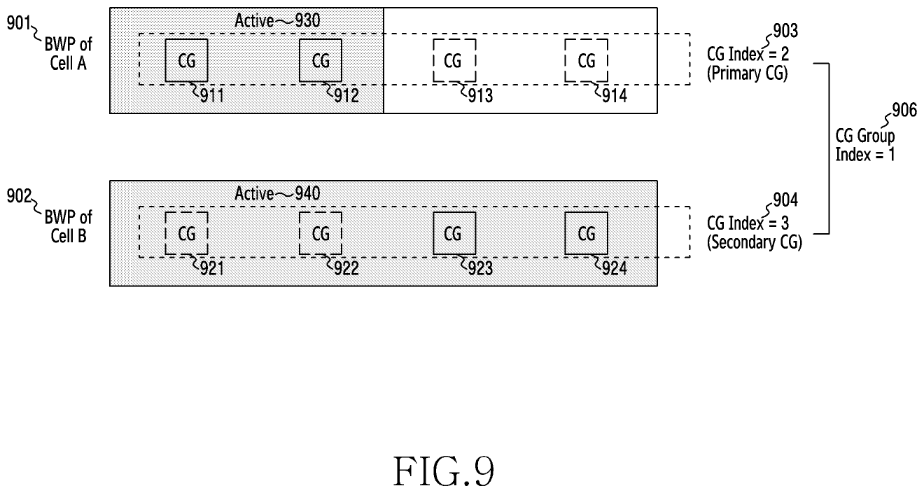

FIG. 9 is a diagram illustrating an operation scheme of a CG group according to an embodiment of the disclosure.

According to an embodiment of the disclosure, when a base station configures CG resources which are uplink (transmission to the base station by a UE) radio resources periodically configured for a UE, the CG resources may be configured by an RRC reconfiguration message that the base station transmits to the UE. The CG resources may be configured on a BWP. The base station may configure at least one BWP, and the at least one BWP may be activated or deactivated by the base station. An activated BWP is referred to as an active BWP.

The embodiment of FIG. 9 illustrates one BWP 901 among BWPs of cell A and one BWP 902 among BWPs of cell B, but one or more BWPs may be configured for each cell. The embodiment illustrates that periodic CG transmission resources 911, 912, 913, and 914 are configured for BWP 901 of cell A, and other periodic CG transmission resources 921, 922, 923, and 924 are configured for BWP 902 of cell B. It is assumed that CG configured for BWP 901 of cell A has a CG index value 903 of 2, and CG configured for BWP 902 of cell B has a CG index value 904 of 3. CG of index 2 and CG of index 3 are configured to be in the same CG group, and indicate to have a CG group index 905 of 1 indicating which group it is.

The embodiment of FIG. 9 illustrates a method of using only one CG at a specific time point within a plurality of CGs configured as a CG group. In the wireless communication network, there may be one active BWP per cell at a specific time point, and a CG transmission resource configured for a BWP other than the active BWP cannot be used. CG resources may be used for data transmission performed periodically and continuously, and in this case, incapability of using the CG resources due to deactivation of a BWP may reduce transmission efficiency. Conversely, there may be no need to use two or more CG resources within a CG group. Therefore, an operation of using one CG resource of CG configured within the CG group may be required. To this end, priorities of CG resources within the CG group may be configured.

The embodiment of FIG. 9 illustrates an operation in which the CG having the CG index 903 of 2 configured for BWP 901 of cell A is configured as primary CG, and the CG having the CG index 904 of 3 configured for BWP 902 of cell B is configured as secondary CG, wherein the CG having the CG index of 2 has priority.

Specifically, if primary CG resources are configured for a current active BWP, the UE may perform data transmission using the primary CG resources. If the primary CG resources are not resources configured for the current active BWP (in case of resources configured for a deactivated BWP), the UE may perform data transmission using secondary CG resources.

In the embodiment of FIG. 8, at a point in time when BWP 901 of cell A, for which the primary CG has been configured, is an active BWP, data transmission using the primary CG resources 911 and 912 may be performed, and when the BWP is deactivated, the primary CG resources 913 and 914 cannot be used, so that data transmission using the secondary CG resources 923 and 924 configured for BWP 902 of cell B may be performed. Information on which CG is to be the primary CG may be configured together when the CG is configured in the RRC reconfiguration message.

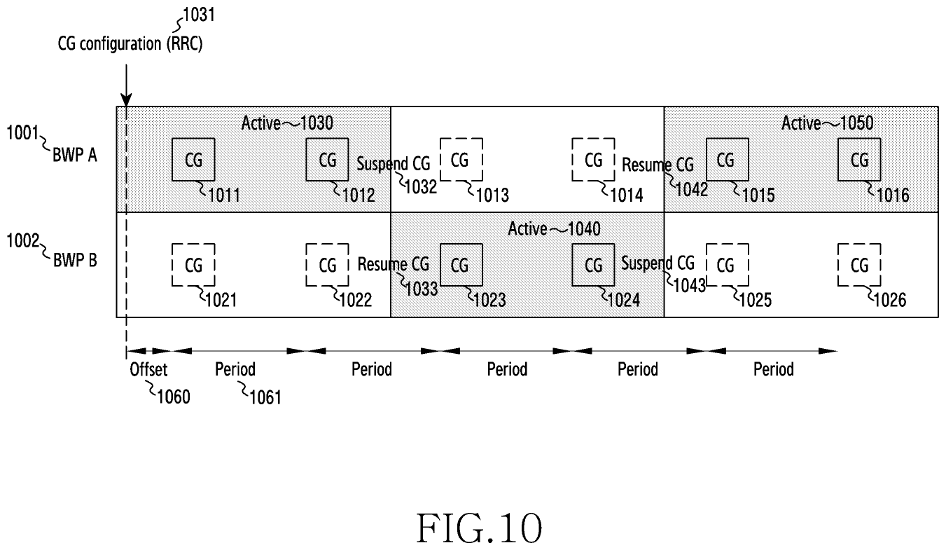

FIG. 10 is a diagram illustrating a CG operation scheme in accordance with BWP switching according to an embodiment of the disclosure.

According to an embodiment of the disclosure, when a base station configures CG resources which are uplink (transmission to the base station by a UE) radio resources periodically configured for a UE, the CG resources may be configured by an RRC reconfiguration message 1031 that the base station transmits to the UE. The CG resources may be configured on a BWP. The base station may configure at least one BWP, and the at least one BWP may be activated or deactivated by the base station. An activated BWP is referred to as an active BWP.

In the embodiment of FIG. 10, two BWPs of BWP A 1001 and BWP B 1002 are configured, periodic CG transmission resources 1011, 1012, 1013, 1014, 1015, and 1016 are configured for BWP A 1001, and other periodic CG transmission resources 1021, 1022, 1023, 1024, 1025, and 1026 are configured for BWP B 1002. In the embodiment of FIG. 10, it is assumed that CG configured for BWP A 1001 and CG configured for BWP B 1002 have the same offset 1060 and period 1061, but these configured CGs may have different offsets and periods.

According to an embodiment of the disclosure, the CG resources may be divided into a first type of CG and a second type of CG. The first type of CG may refer to CG resources used immediately after being configured by an RRC reconfiguration message, and the second type of CG may refer to CG resources indicating CG resource activation to a UE by a base station in a downlink control information (DCI) message of a physical downlink control channel (PDCCH) by using configured scheduling radio network temporary identity (CS-RNTI) after the CG transmission resources are configured by an RRC reconfiguration message.

The embodiment of FIG. 10 illustrates an operation of the first type of CG resources. Therefore, as soon as the CG resources are configured, the corresponding CG transmission resources may be actually used without a separate activation operation, and the UE may perform data transmission using the CG resources to the base station. For the first type of CG resources, the base station may determine an offset 1060 value, at which the CG resources start, by using a reference system frame number (SFN) value configured by the RRC reconfiguration message at a point in time when the UE configures the CG resources, and then periodic CG resources may be configured to be repeated at a regular period 1061. The embodiment of FIG. 10 illustrates that, since CG has been configured, the UE may use the CG transmission resources configured for BWP A 1001 that is the current active BWP. Then, the CG transmission resources 1011 and 1012 configured for BWP A 1001 are activated, and the UE may perform data transmission.

Data transmission using the CG resources may be performed only when the BWP for which CG has been configured is activated. At a point in time when BWP B 1002 is not an active BWP, the CG transmission resources 1021, 1022, 1025, and 1026 configured for BWP B 1002 are not actually used. In addition, exact locations of the CG resources may not be configured.

If the active BWP is changed to BWP B 1002 later, the CG resources configured for BWP A 1001 that is the existing active BWP are suspended 1032, and the CG resources 1013 and 1014 of BWP A are not used. However, locations of the CG resources 1013, 1014, 1015, and 1016 configured for BWP A 1001 may be maintained by the UE and the base station, and may be prepared for use when BWP A 1001 later becomes the active BWP again. This indicates that the base station configures periodic CG resources by using a reference system frame number (SFN) at a point in time when the UE configures the CG resources, so that the CG resources are repeated at a regular period. That is, even if the BWP is deactivated, the UE has location information of the CG resources, and even when the BWP becomes an active BWP later, CG resources having the same period (interval) may be used. To this end, an operation of suspending the CG resources when the BWP is deactivated and resuming the CG resources later when the BWP becomes the active BWP may be performed.

According to an embodiment of the disclosure, the operation of resuming the CG resources may function so that transmission time points of the CG resources 1011 and 1021 starting at the point in time when the CG is configured are repeated at the regular period 1061. For the first type of CG configured for BWP B 1002 that is the active BWP, the CG resources 1023 and 1024 may be resumed 1033 immediately without a separate activation stage. Similarly, if the active BWP is changed back to BWP A 1001 later, the CG resources configured for BWP B that is the existing active BWP are suspended 1043, and the CG resources 1025 and 1026 of BWP B are not used. However, locations of the CG resources 1025 and 1026 configured for BWP B 1002 may be maintained by the UE and the base station, and may be prepared for use when BWP B 1002 later becomes the active BWP again. For the first type of CG configured for BWP A 1001 that is the active BWP, the CG resources 1015 and 1016 may be resumed 1042 immediately without a separate activation stage. According to the scheme proposed in the embodiment of FIG. 10, the period of the CG resources may be maintained constant even when the BWP switching operation in which the active BWP of the UE is changed is performed.

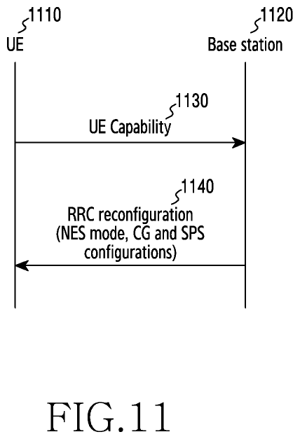

FIG. 11 is a diagram illustrating UE capability transmission and RRC configuration schemes according to an embodiment of the disclosure.

According to an embodiment of the disclosure, a UE 1110 may transmit UE capability information for the aforementioned SPS and CG operations to a base station 1120. In an embodiment, when a BWP for which SPS or CG transmission resources are configured is deactivated, the SPS or CG transmission resources are suspended without being cleared, and then, later when the BWP is activated again as an active BWP, the UE may report, to the base station, whether the UE supports an operation of resuming the SPS or SPS resources.

In addition, according to an embodiment of the disclosure, whether the UE supports a type change of SPS or CG by a MAC CE may be reported. In addition, the UE may report, to the base station, whether the UE supports operations according to an SPS group or a CG group.

In addition, according to an embodiment of the disclosure, the UE may report 1130, to the base station, whether the UE supports UE operations for saving network energy. Based on this, the base station may configure 1140 the operations supported by the UE by an RRC message. Information configured here may be at least one of the SPS configuration, CG configuration, and UE operations for network energy saving.

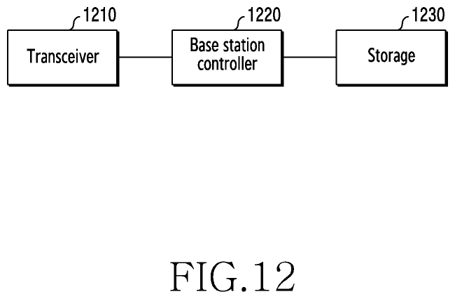

FIG. 12 illustrates a structure of a base station according to an embodiment of the disclosure.

Referring to FIG. 12, the base station may include a transceiver 1210, a controller 1220, and a storage 1230. The transceiver 1210, the controller 1220, and the storage 1230 may be operated according to the above-described communication methods of the base station. In addition, network devices may correspond to the structure of the base station. However, components of the base station are not limited to the above-described example. For example, the base station may include a larger or smaller number of components than the above-described components. Furthermore, the transceiver 1210, the controller 1220, and the storage 1230 may be implemented in the form of a single chip.

The transceiver 1210 refers to a base station receiver and a base station transmitter as a whole, and may transmit/receive signals with the UE, other base stations, and other network devices. The transmitted/received signals may include control information and data. The transceiver 1210 may transmit, for example, system information, synchronization signals, or reference signals to the UE. To this end, the transceiver 1210 may include an RF transmitter configured to up-convert and amplify the frequency of transmitted signals, an RF receiver configured to low-noise-amplify received signals and down-convert the frequency thereof, and the like. However, this is only an embodiment of the transceiver 1210, and the components of the transceiver 1210 are not limited to the RF transmitter and the RF receiver. The transceiver 1210 may include wired/wireless transceivers, and may include various components for transmitting/receiving signals. In addition, the transceiver 1210 may receive signals through a communication channel (e.g., a radio channel), output the same to the controller 1220, and transmit signals output from the controller 1220 through the communication channel. Furthermore, the transceiver 1210 may receive communication signals, output same to a processor, and transmit signals output from the processor to the UE, other base stations, or other network entities through a wired/wireless network.

The storage 1230 may store programs and data necessary for operations of the base station. In addition, the storage 1230 may store control information or data included in signals acquired by the base station. The storage 1230 may include storage media such as a ROM, a RAM, a hard disk, a CD-ROM, and a DVD, or a combination of storage media. In addition, the storage 1230 may store at least one of information transmitted/received through the transceiver 1210 and information generated through the controller 1220.

As used herein, the controller 1220 may be defined as a circuit, an application specific integrated circuit, or at least one processor. The processor may include a communication processor (CP) which performs control for communication and an application processor (AP) which controls upper layers such as application programs. The controller 1220 may control the overall operation of the base station according to the embodiments proposed in the disclosure. For example, the controller 1220 may control signal flows between the respective blocks to perform operations according to the above-described flowcharts.

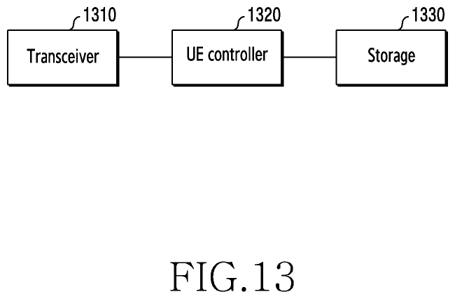

FIG. 13 illustrates a structure of a UE according to an embodiment of the disclosure.

Referring to FIG. 13, the UE may include a transceiver 1310, a controller 1320, and a storage 1330. The transceiver 1310, the controller 1320, and the storage 1330 may be operated according to the above-described communication methods of the UE. Components of the UE are not limited to the above-described example. For example, the UE may include a larger or smaller number of components than the above-described components. Furthermore, the transceiver 1310, the controller 1320, and the storage 1330 may be implemented in the form of a single chip.

The transceiver 1310 refers to a UE receiver and a UE transmitter as a whole, and may transmit/receive signals with the base station, other UEs, and other network entities. The signals transmitted/received with the base station may include control information and data. The transceiver 1310 may receive, for example, system information, synchronization signals, or reference signals from the base station. To this end, the transceiver 1310 may include an RF transmitter configured to up-convert and amplify the frequency of transmitted signals, an RF receiver configured to low-noise-amplify received signals and down-convert the frequency thereof, and the like. However, this is only an embodiment of the transceiver 1310, and the components of the transceiver 1310 are not limited to the RF transmitter and the RF receiver. Also, the transceiver 1310 may include wired/wireless transceivers, and may include various components for transmitting/receiving signals. In addition, the transceiver 1310 may receive signals through a radio channel, output the same to the controller 1320, and transmit signals output from the controller 1320 through the radio channel. Furthermore, the transceiver 1310 may receive communication signals, output same to a processor, and transmit signals output from the processor to network entities through a wired/wireless network.

The storage 1330 may store programs and data necessary for operations of the UE. In addition, the storage 1330 may store control information or data included in signals acquired by the UE. The storage 1330 may include storage media such as a ROM, a RAM, a hard disk, a CD-ROM, and a DVD, or a combination of storage media.

As used herein, the controller 1320 may be defined as a circuit, an application specific integrated circuit, or at least one processor. The processor may include a communication processor (CP) which performs control for communication and an application processor (AP) which controls upper layers such as application programs. The controller 1320 may control the overall operation of the base station according to the embodiments proposed in the disclosure. For example, the controller 1320 may control signal flows between the respective blocks to perform operations according to the above-described flowcharts.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a user equipment (UE) in a wireless communication system, the method comprising:
receiving, from a base station (BS), information on a first bandwidth part (BWP) and a second BWP, and configuration information for a periodic resource configured for each of the first BWP and the second BWP;
receiving, from the BS, first downlink control information for activating a first periodic resource configured for the first BWP which is an active BWP;
performing data transmission and reception, based on the activated first periodic resource;
receiving, from the BS, active BWP change information for activating the second BWP; and
suspending use of the activated first periodic resource configured for the first BWP,
wherein the suspended use of the first periodic resource is resumed without reception of the first downlink control information in case that the first BWP is activated.

2. The method of claim 1, wherein the periodic resource is at least one of a semi-persistent scheduling (SPS) resource related to downlink or a configured grant (CG) resource related to uplink.

3. The method of claim 1, further comprising transmitting, to the BS, capability information related to a periodic resource-based operation,
wherein the capability information comprises information indicating whether to support an operation in which the use of the first periodic resource of the first BWP, suspended at activation of the second BWP, is resumed without reception of the first downlink control information at activation of the first BWP.

4. The method of claim 2,
wherein, in case that the periodic resource is the SPS resource, a type of the periodic resource comprises a first type of SPS and a second type of SPS,
wherein the SPS resource based on the first type of SPS is a resource in which, according to deactivation of a BWP, use of the SPS resource configured for the deactivated BWP is suspended, and the suspended use of the SPS resource is resumed according to activation of the deactivated BWP,
wherein the SPS resource based on the second type of SPS is a resource in which, according to deactivation of a BWP, a configuration on the SPS resource configured for the deactivated BWP is cleared, and
wherein the method further comprises receiving, from the BS, information indicating a change of the type of the periodic resource.

5. The method of claim 4,
wherein, in case that the periodic resource is the CG resource, a type of the periodic resource comprises a first type of CG, a second type of CG, and a third type of CG,
wherein the CG resource based on the first type of CG is a resource in which, according to deactivation of a BWP, use of the CG resource configured for the deactivated BWP is suspended, and the suspended use of the CG resource is resumed according to activation of the deactivated BWP,
wherein the CG resource based on the second type of CG is a resource immediately activated without reception of the first control information according to activation of a BWP, and
wherein the CG resource based on the third type of CG is a resource in which, according to deactivation of a BWP, a configuration on the CG resource configured for the deactivated BWP is cleared.

6. The method of claim 1,
wherein the first periodic resource and a second periodic resource configured for the second BWP have the same group index,
wherein, in case that the first downlink control information comprises the same group index, the second periodic resource is activated with the first periodic resource, based on the same group index, and
wherein the second periodic resource is suspended immediately after activation, and the suspended second periodic resource is resumed without reception of the first downlink control information at activation of the second BWP.

7. The method of claim 1,
wherein the first BWP is included in a first cell, and a third BWP for which a third periodic resource is configured is included in a second cell different from the first cell so as to be activated,
wherein the first periodic resource and the third periodic resource have the same group index, and priority between the first periodic resource and the third periodic resource is configured,
wherein, in case that the first downlink control information comprises the same group index, the third periodic resource is activated with the first periodic resource, based on the same group index, and
wherein the performing of the data transmission and reception is executed based on the third periodic resource of the second cell at deactivation of the first BWP of the first cell in case that priority of the first periodic resource is higher than priority of the second periodic resource.

8. A method performed by a base station (BS) in a wireless communication system, the method comprising:
transmitting, to a user equipment (UE), information on a first bandwidth part (BWP) and a second BWP, and configuration information for a periodic resource configured for each of the first BWP and the second BWP;
transmitting, to the UE, first downlink control information for activating a first periodic resource configured for the first BWP that is an active BWP;
performing data transmission and reception, based on the activated first periodic resource;
transmitting, to the UE, active BWP change information for activating the second BWP; and
suspending use of the activated first periodic resource configured for the first BWP,
wherein the suspended use of the first periodic resource is resumed without transmission of the first downlink control information in case that the first BWP is activated.

9. The method of claim 8, wherein the periodic resource is at least one of a semi-persistent scheduling (SPS) resource related to downlink or a configured grant (CG) resource related to uplink.

10. The method of claim 8, further comprising:
transmitting, to the BS, capability information related to a periodic resource-based operation,
wherein the capability information comprises information indicating whether to support an operation in which the use of the first periodic resource of the first BWP, suspended at activation of the second BWP, is resumed without reception of the first downlink control information at activation of the first BWP.

11. The method of claim 9,
wherein, in case that the periodic resource is the SPS resource, a type of the periodic resource comprises a first type of SPS and a second type of SPS,
wherein the SPS resource based on the first type of SPS is a resource in which, according to deactivation of a BWP, use of the SPS resource configured for the deactivated BWP is suspended, and the suspended use of the SPS resource is resumed according to activation of the deactivated BWP,
wherein the SPS resource based on the second type of SPS is a resource in which, according to deactivation of a BWP, a configuration on the SPS resource configured for the deactivated BWP is cleared, and
wherein the method further comprises transmitting, to the UE, information indicating a change of the type of the periodic resource.

12. The method of claim 11,
wherein, in case that the periodic resource is the CG resource, a type of the periodic resource comprises a first type of CG, a second type of CG, and a third type of CG,
wherein the CG resource based on the first type of CG is a resource in which, according to deactivation of a BWP, use of the CG resource configured for the deactivated BWP is suspended, and the suspended use of the CG resource is resumed according to activation of the deactivated BWP,
wherein the CG resource based on the second type of CG is a resource immediately activated without reception of the first control information according to activation of a BWP, and
wherein the CG resource based on the third type of CG is a resource in which, according to deactivation of a BWP, a configuration on the CG resource configured for the deactivated BWP is cleared.

13. The method of claim 8,
wherein the first periodic resource and a second periodic resource configured for the second BWP have the same group index,
wherein, in case that the first downlink control information comprises the same group index, the second periodic resource is activated with the first periodic resource, based on the same group index, and
wherein the second periodic resource is suspended immediately after activation, and the suspended second periodic resource is resumed without reception of the first downlink control information at activation of the second BWP.

14. A user equipment (UE) in a wireless communication system, the UE comprising:
a transceiver; and
a controller connected to the transceiver,
wherein the controller is configured to perform:
receiving, from a base station (BS), information on a first bandwidth part (BWP) and a second BWP, and configuration information for a periodic resource configured for each of the first BWP and the second BWP,
receiving, from the BS, first downlink control information for activating a first periodic resource configured for the first BWP that is an active BWP,
performing data transmission and reception, based on the activated first periodic resource,
receiving, from the BS, active BWP change information for activating the second BWP, and
suspending use of the activated first periodic resource configured for the first BWP,
wherein the suspended use of the first periodic resource is resumed without reception of the first downlink control information in case that the first BWP is activated.

15. A base station (BS) in a wireless communication system, the BS comprising:
a transceiver; and
a controller connected to the transceiver,
wherein the controller is configured to perform:
transmitting, to a user equipment (UE), information on a first bandwidth part (BWP) and a second BWP, and configuration information for a periodic resource configured for each of the first BWP and the second BWP,
transmitting, to the UE, first downlink control information for activating a first periodic resource configured for the first BWP that is an active BWP,
performing data transmission and reception, based on the activated first periodic resource,
transmitting, to the UE, active BWP change information for activating the second BWP, and
suspending use of the activated first periodic resource configured for the first BWP,
wherein the suspended use of the first periodic resource is resumed without transmission of the first downlink control information in case that the first BWP is activated.
